(19) United States
(12) Patent Application Publication
(10) Pub. No.: US 2018/0077924 A1
(43) Pub. Date: Mar. 22, 2018

(54) TRIGLYCERIDE-CONTAINING DORMANCY SPRAYS

(71) Applicant: BAYER INTELLECTUAL PROPERTY GMBH, Monheim Am Rhein (DE)

(72) Inventors: Ronald VERMEER, Monheim (DE); Peter BAUR, Schondorf (DE); Oliver GAERTZEN, Koln (DE); Christian NAGEL, Singapore (SG); Matthias HAAS, Leichlingen (DE)

(21) Appl. No.: 15/782,513

(22) Filed: Oct. 12, 2017

Related U.S. Application Data
(62) Division of application No. 13/086,565, filed on Apr. 14, 2011, now abandoned.
(60) Provisional application No. 61/327,289, filed on Apr. 23, 2010.

(30) Foreign Application Priority Data
Apr. 23, 2010 (EP) 10160859.4

(51) Int. Cl. A01N 25/02; A01N 43/24; A01N 43/40; A01N 47/06; A01N 47/40; A01N 51/00; A01N 53/00; A01N 57/12; A01N 57/14; A01N 57/16

(52) U.S. Cl. CPC A01N 25/02; A01N 43/24; A01N 43/40; A01N 47/06; A01N 57/16; A01N 51/00; A01N 53/00; A01N 57/12; A01N 57/14; A01N 47/40

(57) ABSTRACT

There is described a suspension concentrate, containing the following components:
(a) at least one agrochemical active substance which is solid at room temperature;
(b) at least one oil, selected from the group consisting of mineral oils and/or liquid paraffins; and
(c) at least one emulsifier; and
(d) at least one triglyceride.

This application is a divisional application of U.S. application Ser. No. 13/086,565, filed Apr. 14, 2011, which claims the benefit of U.S. Provisional Application No. 61/327,289, filed Apr. 23, 2010, and to EP 10160859.4, filed Apr. 23, 2010, the contents of each are incorporated herein by reference in their entireties.

The present invention relates to oil-based suspension concentrates, to processes for their preparation, and to their use for the application of agrochemical active substances.

The present invention furthermore relates to the use of specific adjuvants for improving the deposition rate of agrochemical formulations on plants.

In practical fruit growing, so-called dormancy sprayings (pre-sprays applied before the growing season) are frequently carried out early in the season in order to control overwintering stages of various insects. At that point in time, the trees are still in a dormancy stage, which avoids undesired interactions between beneficial insects and plant protection products, as might occur during flowering. When carrying out these dormancy sprayings, a substantial amount of what is known as a dormant oil is applied at a point in time at which there are neither leaves nor blossom on the trees to be treated. In general, dormant oils are mineral-oil-based formulations, which additionally contain further formulation auxiliaries, for example emulsifiers. A typical application rate per hectare is approximately 40 or more litres of a dormant oil, which is diluted with 1000 to 1500 litres of water to give a spray mixture, which is then applied.

Harmful insects which can be controlled with this method are, for example, scale insects (for example Pseudococcus and Planococcus), mites (for example Aceria anthocoptes) and overwintering stages (for example eggs and larvae) of spider mites (Panonychus sp.), scale insects (for example Quadraspidiotus perniciosus) and aphids (for example Dysaphis plantaginea).

However, the experience of many years has shown that the control of the various early aphid species (Dysaphis plantaginea or Myzus persicae) is frequently insufficient. Therefore, it is usual to apply an oil-based dormancy spray in combination with an insecticide in order to improve the activity against aphids. The insecticide may be added to the spray mixture after the concentrated formulation has been diluted (tank mix) or else incorporated into the oil base as a ready mix (in-can formulation).

A report by Cantoni et al. (Pflanzenschutz-Nachrichten Bayer 54/200, 3) describes both the bio-logical activity and the nontoxicity to bees when applying a mixture of Oliocin® (an oil-based formulation for treatment during winter and when growth resumes, from Bayer CropScience AG) and Confidor® SL 200 (an insecticidal formulation from Bayer CropScience AG) as a tank mix.

To avoid dosing errors and to improve user safety when employing agrochemical products, however, it is advantageous to incorporate the additives into the formulation, as is the case for example in what are known as in-can formulations. Furthermore, this avoids the unnecessary use of extra packaging material for the products when using them as tank mixes.

An example of such an in-can formulation is “Confidor® Oil SC 004” (a suspoemulsion formulation from Bayer CropScience AG), which contains both imidacloprid and a mineral oil dispersed in water. This in-can formulation is employed as a dormant oil for dormancy spraying; however, the type of formulation has some disadvantages.

Thus, firstly, the preparation of this formulation is difficult and complicated because too high an energy input may rapidly cause curdling in the product. Curdling means that a water-in-oil emulsion and not an oil-in-water emulsion is formed, which leads to a drastic rise in viscosity. Secondly, even this product is usually employed at rates of 40 and more litres per hectare, which means more labour and, for example, increased transport costs for the farmer. Furthermore, the high application rates per hectare lead to a separate pollution of the environment because the trees to be treated, since they have no leaves, have very little adhesion surface, which results in what is known as run-off (in other words, the product does not adhere and runs off).

A further disadvantage of the known in-can formulations is the low deposition rate on the sprayed plant, which is obtained with the formulations. It is known from the literature that the deposition rate of plant oils and mineral oils or liquid paraffins can be improved by employing alkylsiloxanes (EP 0 737 420 A). The mechanism of action of these additives is based on a reduced surface tension. A disadvantage of these alkylsiloxanes is that they are stable within a narrow pH range only, so that the possibilities of combining them with a wide range of active substances are limited. Moreover, EP 0 737 420 A does not describe any method with which alkylsiloxanes and at least one active substance in undissolved form can be incorporated into an oil phase, which entails substantial technical difficulties.

Therefore, there continues to be a demand for formulations, in particular suspension concentrates, which can be used for dormancy spraying and which avoid the above-described disadvantages of the prior art. In particular, it is intended to improve the deposition rate of the formulation on the plants with the aid of the formulations according to the invention.

It is therefore an object of the present invention to provide suspension concentrates of agrochemical active substances which are suitable as dormancy sprays and with which the deposition rate of the formulation on the plants is preferably improved in comparison with the prior art. Moreover, the desired deposition rate of the suspension concentrate shall preferably be possible while simultaneously reducing the application rates.

This object is achieved by a suspension concentrate comprising the following components:
(a) at least one agrochemical active substance which is solid at room temperature;
(b) at least one oil, selected from the group consisting of mineral oils and/or liquid paraffins; and
(c) at least one emulsifier.

The suspension concentrate according to the invention is characterized in that it additionally comprises
(d) at least one triglyceride.

According to the invention, it has been found that using at least one triglyceride in suitable suspension concentrates of agrochemical active substances improves the deposition rate of the formulation on the plant.

It must be considered as extremely surprising that the mineral-oil- and/or liquid-paraffin-based suspension concentrates according to the invention significantly improve the deposition rate on the sprayed plant. Furthermore, it could not have been predicted that it was possible significantly to reduce the product application rate when using the formulations according to the invention while the biological activity remained the same or was indeed improved in some cases. The patent literature describes that a better spreading behaviour can be achieved by reducing the surface tension by adding an alkylsiloxane or another spreader. This is why it could not have been expected that the triglycerides according to the invention significantly improve the deposition rate on the sprayed plant; adding the triglycerides according to the invention only leads to a minor reduction in the surface tension, but simultaneously causes a surprisingly good spreading behaviour of the oils used.

To illustrate the present invention, the individual components of the suspension concentrate according to the invention will first be described in greater detail in the following text:

### Triglyceride

The suspension concentrates according to the invention comprise at least one triglyceride as component (d). The triglyceride (IUPAC name: triacylglycerol) preferably brings about a high deposition rate of the suspension concentrate on the plant to be treated. For the purposes of the present invention, triglycerides are understood as meaning triple esters of the trihydric alcohol glycerol with three carboxylic acid molecules. Also comprised within the present invention are suspension concentrates in which glycerides are used in which the glycerol has not been reacted completely with the fatty acids and in which free hydroxyl functions are still present.

Suitable triglycerides are preferably those which are based on fractionated fatty acids of vegetable origin. For the purposes of the present invention, the expression “based on fatty acids” is understood as meaning that triglycerides are used which are obtained by reacting glycerol with these fatty acids. Triglycerides which are even more preferably suitable are those which are composed of saturated fatty acids with a chain length of between 6 and 12 C atoms.

Especially preferred in this context are triglycerides based on saturated fatty acids, where the content of fatty acids with a chain length of between 8 and 10 carbon atoms is between 90 and 100% (based on the weight of the fatty acids). Such triglycerides may be composed not only of fatty acids with the same chain length (for example unblended fatty acid triglycerides, such as glycerol trioctanoate (CAS No. 538-23-8) or glycerol tridecanoate (CAS No. 621-71-6)), but also of any feasible mixture of fatty acids with different chain lengths.

Very especially preferred in this context are triglycerides in which the C₈/C₁₀-fatty acids used are classified under CAS Nos. 52622-27-2 or 73398-61-5.

Such commercially available triglycerides are Miglyol® 810 or Miglyol® 812 from SASOL.

The triglyceride content in the suspension concentrates according to the invention can be varied within a substantial range.

In general, the triglyceride content is between 0.5 and 10% by weight, preferably between 1 and 5% by weight, in each case based on the suspension concentrate according to the invention.

### Agrochemical Active Substance

The suspension concentrate according to the invention contains at least one solid agrochemical active substance as component (a).

In the present context, solid agrochemical active substances are understood as meaning all those substances which are suitable for the treatment of plants, whose melting point is above 50° C. and which have an insecticidal and/or acaricidal activity.

Suitable active substances are, in particular, active substances from the class of the neonicotinoids, pyrethroids, organophosphates, carbamates, anthranilamides and the ketoenols.

Suitable active substances are, furthermore, 4-aminobut-2-enolide compounds as described in EP-A-0 539 588 and WO 2007/115644, WO 2007/115643 and WO 2007/115646. In particular 4-{[(6-chloropyrid-3-yl)methyl](2,2-difluoroethyl)amino}furan-2(5H)-one (compound A), whose insecticidal activity has first been described in WO 2007/115644; 4-{[(6-chloropyrid-3-yl)methyl](cyclopropyl)amino}furan-2(5H)-one (compound (B)) and 4-{[(6-chloropyrid-3-yl)methyl](methyl)amino}furan-2(5H)-one (compound (C)), whose insecticidal activity has first been described in EP-A-0 539 588. The compounds can be prepared by the processes described in WO2007/115644 and EP-A-0539588, and they have the following structure:

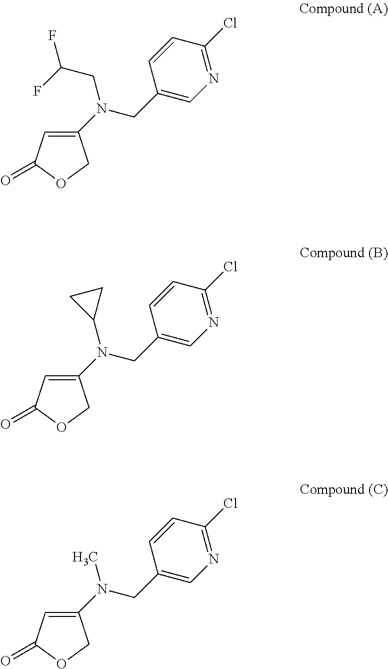 [SMILES: O=C1C=C(N(Cc2ccc(Cl)nc2)CC(F)F)CO1 ; O=C1C=C(N(Cc2ccc(Cl)nc2)C2CC2)CO1 ; CN(Cc1ccc(Cl)nc1)C1=CC(=O)OC1]

Suitable active substances are, furthermore, the sulfoximine active substances as described for example in US Patent Application 2005/228027, WO 2006/060029, WO 2008/027073 WO 2007/095229, WO 2007/149134, WO 2008/097235 and WO 2008/207910, in particular 6-chloropyridin-3-yl]ethyl](methyl)oxido-λA-sulfanylidenecyanamide, of the formula

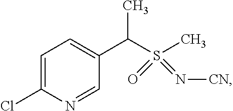

known from US Patent Application 2005/228027 A1, WO 2006/060029, and its diastereomers Compound (D) or Compound (E), of the formula

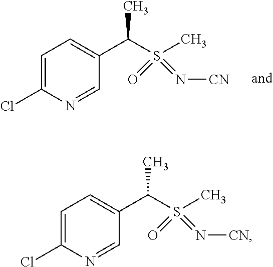

known from US Patent Application 2005/228027 A1 and WO 2007/149134, [6-trifluoromethylpyridin-3-yl]ethyl](methyl)oxido-λ4-sulfanylidenecyanamide (sulfoxaflor) (Compound (F)):

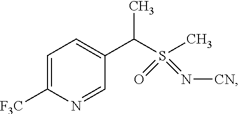 [SMILES: CC(c1ccc(C(F)(F)F)nc1)S(C)(=O)=NC#N]

known from WO 2007/095229, WO 2007/149134, WO 2008/097235 and WO 2008/207910, N-[tetrahydro-1-oxido-2-[6-(trifluoromethyl)-3-pyridinyl)-1H-1λ4-thien-1-ylidene]cyanamide (Compound (G))

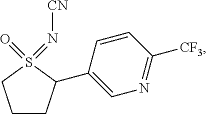 [SMILES: N#CN=S1(=O)CCCC1c1ccc(C(F)(F)F)nc1]

known from WO 2007/095229 A2, and N-[2-(6-chloro-3-pyridinyl)tetrahydro-1-oxido-1H-1λ4-thien-1-ylidene]cyanamide (Compound (H))

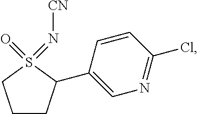 [SMILES: N#CN=S1(=O)CCCC1c1ccc(Cl)nc1]

known from WO 2009/134224 A1.

Compounds which may be mentioned as being especially preferred are chlorantraniliprole (Rynax-ypyr), cyazypyr, imidacloprid, thiamethoxam, clothianidin, dinotefuran, thiacloprid, acetamiprid, deltamethrin, gamma-cyhalothrin, beta-cyfluthrin, transfluthrin, malathion, parathion, chlorpyriphos, dimethoate, endosulfan, sulfoxaflor and spirotetramat, and Compound (A).

Compounds which may be mentioned as being very especially preferred are imidacloprid, thiamethoxam, clothianidin, thiacloprid, acetamiprid and Compound (A).

The agrochemical active substance content in the suspension concentrates according to the invention can be varied within a substantial range.

In general, the agrochemical active substance content is between 0.1 and 5% by weight, preferably between 0.2 and 2% by weight, in each case based on the suspension concentrate according to the invention.

Vegetable Oil, Mineral Oil and/or Liquid Paraffin

The suspension concentrate according to the invention is preferably employed for dormancy spraying and, therefore, contains at least one oil as component (b). This at least one oil may take the form of a mineral oil and/or liquid paraffin. The suspension concentrate according to the invention may additionally also comprise a vegetable oil. The individual oils are described in greater detail hereinbelow.

Suitable vegetable oils are all oils which can be obtained from plants and can conventionally be employed for agrochemical purposes, and mixtures of these oils. Examples which may be mentioned are soya oil, rapeseed oil, corn oil, cornseed oil, sunflower oil, cottonseed oil, linseed oil, safflower oil, walnut oil, peanut oil, olive oil, canola oil or castor oil. Especially preferred are soya oil, rapeseed oil, corn oil or sunflower oil, and their mixtures.

Suitable mineral oils are various commercially available distillation fractions of petroleum. Preferred are mixtures of open-chain C₁₄-C₃₀-hydrocarbons, closed-chain hydrocarbons (naphthenes) and aromatic hydrocarbons. The hydrocarbons may be linear or else branched. Especially preferred mixtures are those with a nonaromatic content of less than 8% by weight. Very especially preferred mixtures are those with a nonaromatic content of less than 4% by weight. An example which may be mentioned here is Exxsol® D140.

Suitable liquid paraffins are linear, branched and cyclic C₁₄-C₃₀-hydrocarbons and their mixtures. Liquid paraffins are also known as base oils or white oils and are commercially available in different qualities. Examples which may be mentioned here are liquid paraffins with the CAS numbers 8042-47-5 (for example Marcol® 82, ExxonMobil, Belgium; Pionier 0032-20, Hansen & Rosenthal KG, Hamburg, Germany; Kristol M14, Carless, Surrey, UK; Ondina® 917, 927, 929, Shell), 64742-46-7 (for example Exxsol D130, ExxonMobil; Banole 50; Total, France), 72623-86-0 (for example Genera-12; Total), CAS 97862-82-3 (for example Genera-9; Total), 92062-35-6 (for example BAR 0020, R.A.M. Oil), 64742-55-8 (for example Flavex® 909, 913, 921, Shell), 64742-54-7 (for example Catenex® T121, Shell), 64742-79-6 (for example Risella® 907, Shell), 64742-65-0 (for example Catenex® S920, Shell), 64741-88-4, 64741-89-5, 64741-97-5 or 8012-95-1.

It is preferred only to use mineral oils or liquid paraffins.

It is especially preferred to use liquid paraffins.

The vegetable oil, mineral oil and/or liquid paraffin content in the suspension concentrates according to the invention can be varied within a substantial range.

In general, the agrochemical active substance content is between 50 and 95% by weight, preferably between 65 and 90% by weight, in each case based on the suspension concentrate according to the invention.

### Emulsifier

The suspension concentrate according to the invention contains at least one emulsifier as component (c).

Preferred emulsifiers are ethoxylated nonylphenols, reaction products of alkylphenols with ethylene oxide and/or propylene oxide, ethoxylated arylalkylphenols, furthermore ethoxylated and propoxylated arylalkylphenols, and sulfated or phosphated arylalkylethoxylates or arylalkylethoxypropoxylates, examples which may be mentioned being sorbitan derivatives such as polyethylene oxide sorbitan fatty acid esters and sorbitan fatty acid esters.

The emulsifier content in the suspension concentrates according to the invention can be varied within a substantial range.

In general, the emulsifier content is between 1 and 10% by weight, preferably between 2 and 7.5% by weight, in each case based on the suspension concentrate according to the invention.

### Further Optional Components

Suitable additives which may be present in the suspension concentrate according to the invention are dispersants, antifreeze agents, antifoams, preservatives, antioxidants, spreaders, water and thickeners.

Preferred dispersants are selected nonionic and/or anionic surfactants.

Suitable nonionic surfactants are all substances of this type which can conventionally be employed in agrochemical compositions. Substances which may be mentioned by preference are polyethylene oxide/polypropylene oxide block copolymers, polyethylene glycol ethers of linear or branched alcohols, reaction products of fatty acids with ethylene oxide and/or propylene oxide, furthermore polyvinyl alcohol, polyvinylpyrrolidone, mixed polymers of polyvinyl alcohol and polyvinylpyrrolidone, and copolymers of (meth)acrylic acid and (meth)acrylates, furthermore alkyl ethoxylates and alkylaryl ethoxylates which can optionally be phosphated and optionally be neutralized with bases, examples which may be mentioned being sorbitol ethoxylates.

Suitable anionic surfactants are all substances of this type which can conventionally be employed in agrochemical compositions. Preference is given to ammonium salts, alkali metal salts and alkaline-earth metal salts of alkylsulfonic acids or alkylarylsulfonic acids, and phosphated or sulfated alkylaryl ethoxylates.

A further preferred group of anionic surfactants or dispersion adjuvants are sparingly oil-soluble salts of polystyrenesulfonic acids, salts of polyvinylsulfonic acids, salts of naphthalenesulfonic acid/formaldehyde condensates, salts of condensates of naphthalenesulfonic acid, phenolsulfonic acid and formaldehyde, and salts of lignosulfonic acid.

Suitable antifreeze agents are all substances of this type which can conventionally be employed in agrochemical compositions. Preferred are urea, glycerol or propylene glycol.

Suitable antifoams are all substances which can conventionally be employed for this purpose in agrochemical compositions. Preferred are silicone oils and magnesium stearate.

Suitable antioxidants are all substances which can conventionally be employed for this purpose in agrochemical compositions. Preferred is butylhydroxytoluene (2,6-di-t-butyl-4-methylphenol, BHT).

Suitable preservatives are all substances which can conventionally be employed for this purpose in agrochemical compositions of this type. Examples which may be mentioned are 2-methylisothiazolinone derivatives (for example Preventol®, Lanxess) and 1,2-benzoisothiazol-3-ones (for example Proxel®).

Suitable spreaders are all substances which can conventionally be employed for this purpose in agrochemical compositions. Preferred are polyether polysiloxanes or organo-modified polysiloxanes.

Suitable thickeners are all substances which can conventionally be employed for this purpose in agrochemical compositions and which act as thickening agents. Preferred are inorganic particles such as carbonates, silicates and oxides, but also organic substances such as urea/formaldehyde condensates. Examples which may be mentioned are kaolin, rutile, silicon dioxide, so-called highly disperse silicas, silica gels and natural and synthetic silicates such as bentonites, attapulgites or montmorillonites, and furthermore talc.

The content of these further additives in the suspension concentrates according to the invention may in each case be varied within a substantial range.

When the suspension concentrates according to the invention contain further additives, the content of the further additives can in each case be in general between 0 and 15% by weight, preferably between 0 and 10% by weight, in each case based on the suspension concentrate according to the invention.

### Further Properties of the Suspension Concentrates According to the Invention

The oil-based suspension concentrates according to the invention are formulations which remain stable, even upon prolonged storage at elevated temperatures or in the cold, since no crystal growth is observed. They can be converted into homogeneous spray liquids by dilution with water. These spray liquids are used by customary methods, like, for example, by spraying.

### Use of the Suspension Concentrates According to the Invention

The present invention furthermore relates to the use of the suspension concentrates according to the invention for the application of agrochemical active substances.

The suspension concentrate according to the invention is employed in particular as a dormancy spray for fruit trees. In this context, the mineral oil and/or liquid paraffin, which is employed as component (b), acts in combination with the at least one agrochemical active substance (component (a)).

The application rate of the oil-based suspension concentrates according to the invention can be varied within a substantial range. It depends on the respective agrochemical active substances and on their content in the formulations, which have been specified above for the individual components.

### Preparation of the Suspension Concentrates According to the Invention

The present invention furthermore relates to a process for the preparation of the suspension concentrates according to the invention.

The suspension concentrates according to the invention are preferably prepared in such a way that the individual components are mixed with each other in the ratios desired in each case. The order in which the components are mixed with each other is as desired. It is expedient to employ the solid components in the finely ground state; in this context, the particle size is generally below 20 μm, preferably between 1 and 10 μm. When employing the solid components in the finely ground state, it is usual to comminute the active substance via an air jet mill, the active substance being present in pure form or in combination with a grinding auxiliary. Alternatively, it is also possible to incorporate the active substance via wet-grinding, in the form of a highly concentrated suspension. However, it is also possible to subject the suspension obtained after mixing the components first to coarse grinding and then to fine grinding, so that the mean particle size is below 20 μm. Preferred suspension concentrates are those in which the solid particles have a mean particle size of between 1 and 10 μm. To increase the efficacy of the grinding process, some of the continuous phase may be left out and added only after comminution.

When carrying out the process according to the invention, the temperatures may be varied within a certain range. Generally, the process is carried out at temperatures of between 10 and 60° C., preferably between 15 and 40° C. Suitable apparatuses for carrying out the process according to the invention are usual mixing and grinding devices which are employed for the preparation of agrochemical formulations.

### Use

The present invention furthermore relates to the use of at least one triglyceride for improving the deposition rate of agrochemical active substances. The triglyceride to be used in accordance with the invention is preferably used in suspension concentrates which are employed in dormancy spraying. The suspension concentrates in question may comprise at least one agrochemical active substance. As regards more information on suitable suspension concentrates, reference is made to what has been said above.

As regards particular embodiments in respect of the triglyceride, reference is, again, made to what has been said above.

The present invention is illustrated in greater detail with reference to the examples which follow.

### PREPARATION EXAMPLES

### Example 1

To prepare a suspension concentrate according to the invention,

6.0 g imidacloprid

### 42.5 g Atlox 3467

### 42.5 g Arlatone T(V)

1.7 g Miglyol 812 N (triglyceride to be used in accordance with the invention)

### 0.8 g Silfoam SC 1132

### 1.7 g Vulkanox BHT

### 1.7 g Aerosil R 812 S

were added with stirring at room temperature to

### 722.5 g Pionier 0032-20.

After the addition had ended, stirring was continued for 10 minutes at room temperature. The homogeneous suspension formed in this process was first subjected to coarse grinding and then to fine grinding to give rise to a suspension in which 90% of the solids particles had a particle size of below 6 μm.

The following formulations 2 to 28 were prepared analogously to Example 1, using different agrochemical active substances (data in % w/w):

TABLE 1

| | 2 | 3 | 4 | 5 | 6 | 7 | 8 | 9 | 10 |
|---|---|---|---|---|---|---|---|---|---|
| imidacloprid | 0.68 | 0.68 | 0.68 | 0.68 | 0.68 | 0.68 | 0.68 | 0.68 | |
| deltamethrin | | | | | | | | | |
| spirotetramat | | | | | | | | | |
| thiacloprid | | | | | | | | | 0.57 |
| acetamiprid | | | | | | | | | |
| clothianidin | | | | | | | | | |
| beta-cyfluthrin | | | | | | | | | |
| Compound (A) | | | | | | | | | |
| sulfoxaflor | | | | | | | | | |
| Vulkanox ® BHT | 0.2 | 0.2 | 0.2 | 0.2 | 0.2 | 0.2 | 0.2 | 0.2 | 0.2 |
| Miglyol ® 812 | 2.0 | 2.0 | 2.0 | 2.0 | 2.0 | | 1.0 | | 2.0 |
| Miglyol ® 810 | | | | | | 2.0 | 1.0 | 2.0 | |
| Arlatone ® T | | | | | | | | 5.0 | |
| Atlox ® 3467 | | | | | | | | 5.0 | |
| Rhodacal ® 60 BE | 2.2 | 2.2 | 2.2 | 2.2 | 2.2 | 2.2 | 2.2 | | 2.2 |
| Rhodasurf ® 420/95 | 1.8 | 1.8 | 1.8 | 1.8 | 1.8 | 1.8 | 1.8 | | 1.8 |
| Preventol ® D 7 | | | | | | | | | |
| Tanemul L 3 | | | | | | | | | |
| Tanemul SO 70 | | | | | | | | | |
| Silfoam ® SRE | | | | | | | | | |
| Proxel ® GXL | | | | | | | | | |
| Tanamul ® PS 54 | | | | | | | | | |
| Atlox ® 4913 | | | | | | | | | |
| water | | | | | | | | | |
| citric acid | | | | | | | | | |
| Silfoam ® SC 1132 | 0.1 | 0.1 | 0.1 | 0.1 | 0.1 | 0.1 | 0.1 | 0.1 | 0.1 |
| Aerosil ® R 812 S | 2.0 | 2.0 | 2.0 | 2.0 | 2.0 | 2.0 | 2.0 | 2.0 | 2.0 |
| Kristol M14 | | | | | 91.02 | | | | |
| Marcol ® 82 | | | | 91.02 | | | | | |
| Genera ® 9 | | | 91.02 | | | | | | |
| Bayol ® 85 | | 91.02 | | | | | | | |
| Pionier ® 0032-20 | 91.02 | | | | | 91.02 | 91.02 | 85.02 | 91.13 |
| sunflower oil | | | | | | | | | |
| Exsoll D 140 | | | | | | | | | |
| | 11 | 12 | 13 | 14 | 15 | 16 | 17 | 18¹ | 19 |
| imidacloprid | | | 0.45 | 0.68 | 0.68 | 0.57 | 0.68 | | |
| deltamethrin | | | | | | | | 0.68 | |
| spirotetramat | | | | | | | | | 0.68 |
| thiacloprid | 0.57 | 0.68 | | | | | | | |
| acetamiprid | | | | | | | | | |
| clothianidin | | | | | | | | | |
| beta-cyfluthrin | | | | | | | | | |
| Compound (A) | | | | | | | | | |
| sulfoxaflor | | | | | | | | | |
| Vulkanox ® BHT | 0.2 | | 0.2 | 0.2 | | 0.2 | 0.2 | | |
| Miglyol ® 812 | 2.0 | 2.0 | 2.0 | 2.0 | 2.0 | 2.0 | 2.0 | 2.0 | 2.0 |
| Miglyol ® 810 | | | | | | | | | |
| Arlatone ® T | 5.0 | | 11.0 | 5.0 | | 5.0 | 5.0 | 5.0 | 5.0 |
| Atlox ® 3467 | 5.0 | | 5.0 | 5.0 | | 5.0 | 5.0 | 5.0 | 5.0 |
| Rhodacal ® 60 BE | | 2.2 | | | 2.2 | | | | |
| Rhodasurf ® 420/95 | | 1.8 | | | 1.8 | | | | |
| Preventol ® D 7 | | | | 0.001 | | | | | |
| Tanemul L 3 | | | | | | | | | |
| Tanemul SO 70 | | | | | | | | | |
| Silfoam ® SRE | | | | 0.0014 | | | | | |
| Proxel ® GXL | | | | 0.0017 | | | | | |
| Tanamul ® PS 54 | | | | 0.028 | | | | | |
| Atlox ® 4913 | | | | 0.064 | | | | | |
| water | | | | 0.4 | | | | | |
| citric acid | | | | | | | | 0.2 | 0.2 |
| Silfoam ® SC 1132 | 0.1 | 0.1 | 0.1 | 0.1 | 0.1 | 0.1 | 0.1 | 0.1 | 0.1 |
| Aerosil ® R 812 S | 2.0 | 2.0 | 2.0 | 2.0 | 2.0 | 2.0 | 2.0 | 2.0 | 2.0 |
| Kristol M14 | | | | | | | | | |
| Marcol ® 82 | | | | | | | | | |
| Genera ® 9 | | | | | 91.22 | | | | |
| Bayol ® 85 | | 93.22 | 79.25 | | | | | | |
| Pionier ® 0032-20 | 85.13 | | | 84.52 | | 85.13 | 85.02 | 85.02 | 85.02 |
| sunflower oil | | | | | | | | | |
| Exsoll D 140 | | | | | | | | | |
| | 20 | 21 | 22 | 23 | 24 | 25 | 26 | 27 | 28 |
| imidacloprid | | | | | | | | 0.68 | 0.68 |
| deltamethrin | | | | | | 0.07 | | | |
| spirotetramat | | | | | | | | | |
| thiacloprid | | | | | | | | | |
| acetamiprid | 0.68 | | | | | | | | |
| clothianidin | | 0.68 | | | | | | | |
| beta-cyfluthrin | | | | | 0.07 | | | | |
| Compound (A) | | | 0.68 | | | | | | |
| sulfoxaflor | | | | 0.68 | | | | | |
| Vulkanox ® BHT | 0.2 | 0.2 | 0.2 | 0.2 | | | | | 0.2 |
| Miglyol ® 812 | 2.0 | 2.0 | 2.0 | 2.0 | 2.0 | 2.0 | 2.0 | 2.0 | 2.0 |
| Miglyol ® 810 | | | | | | | | | |
| Arlatone ® T | 5.0 | 5.0 | 5.0 | 5.0 | 5.0 | 5.0 | 5.0 | 5.0 | 5.0 |
| Atlox ® 3467 | 5.0 | 5.0 | 5.0 | 5.0 | 5.0 | 5.0 | 5.0 | | 5.0 |
| Rhodacal ® 60 BE | | | | | | | | | |
| Rhodasurf ® 420/95 | | | | | | | | | |
| Preventol ® D 7 | | | | | | | | | |
| Tanemul L 3 | | | | | | | | 2.5 | |
| Tanemul SO 70 | | | | | | | | 2.5 | |
| Silfoam ® SRE | | | | | | | | | |
| Proxel ® GXL | | | | | | | | | |
| Tanamul ® PS 54 | | | | | | | | | |
| Atlox ® 4913 | | | | | | | | | |
| water | | | | | | | | | |
| citric acid | | | | | 0.2 | 0.2 | | | |
| Silfoam ® SC 1132 | 0.1 | 0.1 | 0.1 | 0.1 | 0.1 | 0.1 | 0.1 | 0.1 | 0.1 |
| Aerosil ® R 812 S | 2.0 | 2.0 | 2.0 | 2.0 | | | | 3.0 | 1.0 |
| Kristol M14 | | | | | | | | | |
| Marcol ® 82 | | | | | | | | | |
| Genera ® 9 | | | | | | | | | |
| Bayol ® 85 | | | | | | | | | |
| Pionier ® 0032-20 | 85.02 | 85.02 | 85.02 | 85.02 | 87.63 | 87.63 | 87.9 | | |
| sunflower oil | | | | | | | | | 86.02 |
| Exsoll D 140 | | | | | | | | 84.22 | |

¹During the preparation, the temperature was kept below 25° C.
Note:
Example 28 is a comparative example.

### Comparative Example 1

To prepare a suspension concentrate,

| | | |
|---|---|---|
| 2.7 | g | imidacloprid |
| 34.1 | g | Atlox 3467 |
| 68.2 | g | Arlatone T(V) |
| 12 | g | Break Thru OE 441 (adjuvant for |
| | | improving the deposition rate) |
| 0.7 | g | Silfoam SC 1132 |
| 1.4 | g | Vulkanox BHT |
| 12 | g | Aerosil R 812 S |

were added with stirring at room temperature to

| | | |
|---|---|---|
| 467.3 | g | Bayol 85. |

After the addition had ended, stirring was continued for 10 minutes at room temperature. The homogeneous suspension formed in this process was first subjected to coarse grinding and then to fine grinding to give rise to a suspension in which 90% of the solids particles had a particle size of below 6 μm.

### Comparative Example 2

To prepare a suspension concentrate,

| | | |
|---|---|---|
| 2.7 | g | imidacloprid |
| 34.1 | g | Atlox 3467 |
| 68.2 | g | Arlatone T(V) |
| 12 | g | Surfonyl 104 S (adjuvant for |
| | | improving the deposition rate) |
| 0.7 | g | Silfoam SC 1132 |
| 1.4 | g | Vulkanox BHT |
| 12 | g | Aerosil R 812 S |

were added with stirring at room temperature to

| | | |
|---|---|---|
| 479.3 | g | Bayol 85. |

After the addition had ended, stirring was continued for 10 minutes at room temperature. The homogeneous suspension formed in this process was first subjected to coarse grinding and then to fine grinding to give rise to a suspension in which 90% of the solids particles had a particle size of below 6 μm.

The components, defined by their trade names, of the above-described compositions are obtainable from the following suppliers:

| Trade name | Type of compound | Supplier |
|---|---|---|
| Aerosil ® R 812 S | hydrophobicized highly disperse silicon | Evonik Degussa |
| | dioxide | |
| Arlatone ® ® T | PEG-40 sorbitan peroleate, nonionic | Croda |
| Atlox ® 3467 | mixture of nonionic and anionic surfactants | Croda |
| Atlox ® 4913 | polymeric nonionic surfactant | Croda |
| Bayol ® 85 | white oil | Exxon Mobil |
| Break Thru ® OE 441 | polyether siloxane | Evonik |
| Exsoll ® D 140 | hydrocarbon fluid | Exxon Mobil |
| Genera ® 9 | white oil | Total |
| Kristol ® M14 | white oil | Carless |
| Marcol ® 82 | white oil | Exxon Mobil |
| Miglyol ® 810 | caprylic/capric triglyceride | Sasol |
| Miglyol ® 812 | caprylic/capric triglyceride | Sasol |
| Pionier ® 0032-20 | white oil | Hansen & Rosenthal KG |
| Preventol ® D 7 | 5-chloro-2-methyl-3(2H)-isothiazolone + 2- | Lanxess |
| | methyl-3(2H)-isothiazolone | |
| Proxel ® GXL | 1,2-benzisothiazol-3(2H)-one | ARCH Chemicals |
| Rhodacal ® 60 BE | calcium dodecylbenzenesulfonate | Rhodia |
| Rhodasurf ® 420/95 | ethoxylated fatty alcohol | Rhodia |
| Solfoam ® SC 1132 | polydimethylsiloxane | Wacker |
| Surfonyl ® 104 S | 2,4,7,9-tetramethyl-5-decyne-4,7-diol | Air Products |
| Tanemul ® L 3 | ethoxylated fatty alcohol | Tanatex |
| Tanamul ® PS 54 | tristyryphenol ethoxylate | Tanatex |
| Tanemul ® SO 70 | fatty acid poly(ethylene glycol) ether | Tanatex |
| Vulkanox ® BHT | 2,6-di-tert-butyl-4-methylphenol | Lanxess |

### Use Examples

The standard employed is the commercially available oil-containing formulation with the trade name “Confidor Oil SC 004”. This formulation is a suspension concentrate of the active substance imidacloprid, which is composed of the active substance, an oil and further adjuvants but—in contrast to the formulations according to the invention—does not contain any triglyceride.

### Example I

### Deposition on Plant Parts Following Spray Application

To determine the deposition rate of buds and twigs following the application of various oil-based formulations which contain the active substance imidacloprid, standardized laboratory experiments were carried out. To this end, the oil-based formulations in question were applied, with the aid of fluorescent markers from the group of the stilbene derivatives, at the same use concentration (40 g a.i./ha) to plant parts, and the deposition rate was subsequently determined.

The spray experiments were carried out using a laboratory spray device (CheckTec) which permits field-analogous spray treatments to be carried out with nozzles, water volumes and pressures conventionally used in practice. In each case, a water application rate of 500 litres per hectare was applied, and the spray head was always equipped with a fan nozzle. The plant parts were buds or branches of apple (cultivar Golden Delicious) and sweet cherry (cultivar Sunburst). To retain turgescence, the branches were cut underwater and stored standing in tap water until the application was carried out. The orientation of the branches upon spray application was always at a right angle to the direction of the spray mist. In the case of the buds, either the side or the tip of the buds was facing the spray mist.

The preparations were made up with tap water and mixed for at least half an hour before application, using a magnetic stirrer.

After the application, the time taken until the spray mixture had evaporated was allowed to elapse, i.e. until the plant parts were macroscopically dry. For the evaluation, the plant samples were analysed under UV light in an enclosed CAMAG Box. Depending on the intrinsic fluorescence of the plants/plant parts relative to the fluorescence marker, wavelengths of (predominantly) 354 nm or 302 nm were used for the excitation, and digital images were taken using a Sony DSC H-9. In each case one treated plant sample was photographed together with an untreated sample, since the untreated control served for the subsequent evaluation and for taking into consideration the background signal. The evaluation of the deposition rate was carried out using the image evaluation software Soft-Imaging-Systems (SIS, V5.0). To this end, the images were uploaded into the working memory, and a colour separation was performed. After performing a grey-scale conversion of the UV emission image, a threshold value for brightness, which fully covered the untreated plant sample, was detected. All plant parts up to this threshold value are assigned a uniform false colour and describe the portion without deposition in the treated plant sample. Intensities above the threshold value are assigned to the portion with deposition. The plant organ to be studied (bud, twig section) was then excised by image analysis, and the percentage deposition rate as calculated by SIS was documented.

| Product | Deposition on apple buds |
|---|---|
| Table 1, Example 13, 10 L/ha | 80% |
| Comparative Example 1, 10 L/ha | 70% |
| Comparative Example 2, 10 L/ha | 70% |
| Commercial standard (Confidor Oil | 70% |
| SC 004), 10 L/ha | |

Example 13 of Table 1 shows that, in comparison with the commercial standard Confidor Oil SC 004 and other test preparations (Comparative Examples 1 and 29), the deposition rate on apple buds is improved over the standard, while the application rates remain the same.

### Example II

Efficacy Against Populations of the White Peach Scale, or Mulberry Scale, after Spray Application

In Izmir (Turkey), peach trees which are naturally infected with the mulberry scale Pseudaulacaspis pentagona were sprayed once with one formulation according to Example 1 of Table 1 (162 g imidacloprid/ha, or 27 l product) or according to Example 12 of Table 1 (180 g thiacloprid/ha, or 30 l product) or according to Example 16 of Table 1 (160 g imidacloprid/ha, or 321 product) as a spray treatment at the beginning of the season. After 25 and 50 days after the treatment (25 or 50 DAA), the efficacy of the treatment against the mulberry scale was determined in % Abbott (ratio of the number of mulberry scales on treated plant/shoot to the number of mulberry scales on the control) in % Abbott (measure for the efficacy: % live scale insects in the control−live scale insects after the treatment/live scale insects in the control) and compared with the commercial standard Confidor Oil SC 004 (160 g imidacloprid/ha, or 40 l product).

| | Efficacy against mulberry scales | |
|---|---|---|
| | [% Abbott] | |
| Product | 25 DAA | 50 DAA |
| Commercial standard (Confidor | 89.8 | 96 |
| Oil SC 004), 40 l/ha | | |
| Table 1, Example 1, 27 l/ha | 100 | 100 |
| Table 1, Example 16, 32 l/ha | 100 | 100 |
| Table 1, Example 12, 30 l/ha | 93.3 | 97.4 |

Despite the lower oil content, Example 1 of Table 1, with 27 l product/ha, showed a more rapid efficacy (25 DAA) against the mulberry scale than the standard Confidor Oil SC 004 at 40 l product/ha. The long-term control after 50 DAA, too, was slightly better than that of the standard preparation.

### Example III

### Efficacy Against Populations of the Rosy Apple Aphid Following Spray Application

In Bologna (Italy), apple trees where experience has shown that an attack by the rosy apple aphid Dysaphis plantaginea can be expected were sprayed once with Example 1 of Table 1 (54 g imidacloprid/ha and m crown height=162 g imidacloprid/ha, or 27 l product) as a spray treatment at the beginning of the season. After 83 days after the treatment (83 DAA), the efficacy of the treatment against the rosy apple aphids was determined in % Abbott (ratio of the number of apple aphids on treated plant/20 shoots to the number of apple aphids on the control) in % Abbott (measure for the efficacy: % live apple aphids in the control−live apple aphids after the treatment/live apple aphids in the control) and compared with the commercial standard Confidor Oil SC 004 (162 g imidacloprid/ha, or 40 l product).

| | Efficacy against rosy apple aphids | |
|---|---|---|
| | Concentration | |
| | [g a.i./ha | 83 DAA |
| Product | m crown height] | [% Abbott] |
| Mineral oil, 40 l/ha | 0 | 33.7 |
| Commercial standard (Confidor | 54 | 80.8 |
| Oil SC 004),40 l/ha | | |
| Table 1, Example 1, 27 l/ha | 54 | 84.3 |

Example 1 of Table 1 showed, with the same a.i. content, a slightly improved efficacy against the rosy apple aphid in comparison with the standard than the standard Confidor Oil SC 004 and further test preparations. This takes the form of a long-term control after 83 DAA.

The pure mineral oil is only capable of contributing in a minor way to controlling this pest (34% Abbot), and it was only with the formulation according to the invention that these high efficacies could be obtained.

1. A method comprising contacting a plant or plant part with a suspension concentrate, wherein the suspension concentrate comprises
(a) at least one agrochemical active substance which is solid at room temperature, selected from the group consisting of Imidacloprid- and spirotetramat, and wherein the agrochemical active substance is present in an amount of 0.1 to 5% by weight, based on the suspension concentrate;
(b) at least one oil selected from the group consisting of a mineral oil, a liquid paraffin, and a combination thereof wherein the content of the oil in the concentrate is 80 to 95 by weight of the concentrate,
(c) at least one emulsifier; and
(d) at least one triglyceride comprising a saturated fatty acid, wherein the fatty acid has a chain length of 8 to 10 carbon atoms, and is present in an amount of 90 to 100% by weight, based on the total fatty acids in the triglyceride, and wherein the triglyceride is present in an amount of 0.5 to 5% by weight, based on the suspension concentrate,
wherein the at least one agrochemical active substance is present in an oil-phase comprising said at least one oil and is not present in an aqueous phase.

2. The method according to claim 1, wherein the suspension concentrate is a dormancy spray and the plant or plant part is contacted with the dormancy spray before the growing season.

3. The method according to claim 1, wherein the triglyceride is glycerol trioctanoate or glycerol tridecanoate.

4. The method according to claim 1, wherein the suspension concentrate further comprises at least one additive selected from the group consisting of a dispersant, antifreeze agent, antifoam, preservative, antioxidant, spreader, and a thickener.

5. The method according to claim 1, wherein the agrochemical active substance is spirotetramat.

6. The method according to claim 1, wherein the agrochemical active substance is imidacloprid.

7. The method according to claim 1, wherein the content of the agrochemical active substance is between 0.2 and 2% by weight, and the content of the emulsifier is between 2 and 7.5% by weight.

8. The method according to claim 1, wherein the oil is a mineral oil.

9. The method according to claim 1, wherein the oil is a liquid paraffin.

10. The method according to claim 1, wherein neither leaves nor blossom are present on the plant or plant part when it is contacted with the suspension concentrate.

11. The method according to claim 1, wherein the method controls harmful insects

12. The method according to claim 1, wherein the suspension concentrate is applied to a plant or plant part by spraying.

13. The method according to claim 1, wherein the plant or plant part is a tree.

14. The method according to claim 13, wherein the tree is a fruit tree.

15. The method according to claim 14, wherein the plant or plant part is a tree branch.

16. The method according to claim 13, wherein the tree is a peach tree.

17. The method according to claim 13, wherein the tree is an apple tree.

18. The method according to claim 13, wherein the tree is a cherry tree.

19. The method according to claim 11, wherein the harmful insects controlled include rosy apple aphids (Dysaphis plantaginea)

20. The method according to claim 1, wherein mulberry scale (Pseudaulacaspis pentagona) are controlled.
